(19) United States
(12) Patent Application Publication
(10) Pub. No.: US 2003/0023446 A1
(43) Pub. Date: Jan. 30, 2003

(54) On line oral text reader system

(76) Inventors: Susanna Merenyi, Enskede (SE); Dan Jonsson, Stockholm (SE); Thomas Westin, Stockholm (SE)

Correspondence Address: Rolf Fasth, Fasth Law Offices, 189 Curtis Drive, Longview, WA, 98632-5374, US

(21) Appl. No.: 10/239,093

(22) PCT Filed: Mar. 16, 2001
(86) PCT No.: PCT/SE01/00564

(51) Int. Cl. G10L 11/00

(52) U.S. Cl. 704/270.1

(57) ABSTRACT

The method converts visual Internet information to sound by activating a computer (11) with a program stored on a storage media (13). The program (9) provides commands for connecting the computer (11) to an on-line oral web address (12). The program (9) sends a connect signal (25) to the on-line oral web address (12). The on-line oral web address (12) sends a file (23) to a speech synthesizer software (15) of the computer (11). The speech synthesizer software (15) converts the file (23) to sound information.

### TECHNICAL FIELD

The present invention relates to an on-line oral text reader system that orally reads text information on Internet addresses for the user, such as a blind user.

### BACKGROUND AND SUMMARY OF THE INVENTION

The Internet is becoming a very important communication media in everyday life. However, the Internet is still focused on visual messages and blind and other handicapped persons cannot conveniently use the Internet. Many conversion devices have been tried in the past but most systems are either too cumbersome or too expensive to use. There is a need for a reliable and easy system that enables blind and other visually impaired to use the Internet.

The present invention is a method that converts visual Internet information to sound by activating a computer with a program stored on a storage media. The program provides commands for connecting the computer to an on-line oral web address. The program sends a connect signal to the on-line oral web address. The on-line oral web address sends a text file to a speech synthesizer of the computer. The speech synthesizer converts the text file to sound information.

### DESCRIPTION OF THE DRAWINGS

FIG. 1 is a schematic view of the information flow between the user and Internet addresses.

### DETAILED DESCRIPTION

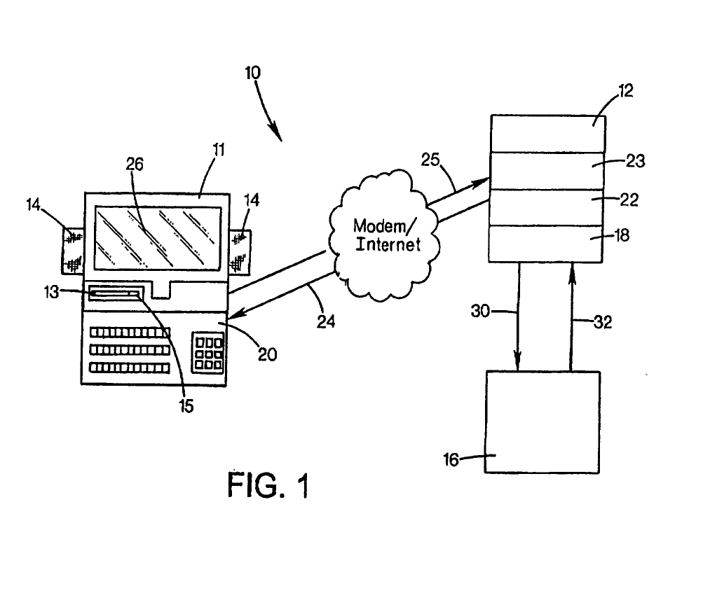

With reference to FIG. 1, the present invention is an on-line oral text reader system that enables blind and other handicapped people to use and have access to the Internet in a convenient manner. The system 10 has a program 9 stored on a CD-rom 13 that has preprogrammed commands that may be activated by inserting the CD-rom 13 into a computer 11 and the user is automatically connected to an on-line oral web address 12. The CD-rom 13 may include program commands so that the computer 11 is automatically connected to the address 12 on the Internet without requiring any input from the blind person. It is important to note that there is no need for the blind user to rely on assistance from others when connecting to the address 12 and that there is no need to instal plug-ins prior to connecting to the address 12. For example, all the necessary plug-ins for the conventional browser on the computer 11 have already been installed on the CD-rom 13 so that the user does not have to instal the plug-ins between the browser and the speech synthesizer of the computer 11 and/or the address 12. The address 12 may also include a speech synthesizer, if desired.

If the connection to the address 12 is not successful, the CD-rom 13 triggers a signal that generates an oral failure message so that the user knows that the user is not properly connected. The CD-rom 13 may include a browser program, such as Netscape Navigator, and a bundled plug-in for a speech synthesizer software 15, such as an Xpress speech synthesizer program, that receives the file 23 before the software (15) converts the text file to sound. Of course, the CD-rom 13 may include any suitable web browser or speech synthesizer program. In the alternative, the user may rely on a speech synthesizer program that is included in the computer 11 itself. However, there is no requirement that the computer 11 has any programs that are especially designed for blind persons so that any computer may be used. In other words, all the necessary information to reach the address 12 is, preferably, on the CD-rom 13 so that the user may use any computer to access the address 12.

The address 12 may be accessed from any suitable browser, such as Netscape Navigator and Internet Explorer, and any platform may be used such as Mac and PC. The address 12 may contain a browser program 22 that is updated continuously so the user will have access to the latest versions of the programs at the address 12 when connected to the address 12 to automatically download the necessary programs such as a navigational program 18. In order to receive oral commands the address 12, the computer 11 must have a loudspeaker 14. If so desired, the address 12 may also contain a speech synthesizer program if the user does not have access to the CD-rom 13.

When the user is connected to the address 12, an automatic command in the CD-rom 13 may send a connection signal 25 to trigger an information link of the address 12 so that the web browser 22 sends a text signal 24 back to the speech synthesizer software 15 confirming that the address 12 has been properly connected to, such as by transmitting sound instructions through the loud speakers 14. The text signal 24 may be used by the synthesizer software 15 to convert the information of the signal 24 to sound. The web browser 22 may be programmed to operate in a wide variety of languages such as English, French, German, Swedish, etc. The text signal may also include some instructions. For example, the user may be asked to type in a desired web page address 16, or any other suitable address as desired by the user, which the user would like to visit and read. The web browser 22 of the address 12 may be any suitable web reader, such as a Macromedia Shockwave program, that may convert web information, such as HTML files, from other sites to a file 23 that may then be converted to sound by using the speech synthesizer software 15. For example, the web browser 22 may decode or parse the HTML file to text information from other sites by removing HTML tags so the synthesizer software 15 can convert the text to sound. The web browser 22 may be navigated by a key board 20 of the computer 11. For example, volume, speed, fast-forward, rewind, pitch, pause, resume, stop and exit are commands that the user may use after the navigational program 18 have been downloaded from the address 12 to the computer 11 and the computer 11 is, via the address 12, properly connected to the address 16. For example, the user may scroll between the different commands by pressing the right arrow on the keyboard 20. The user may also scroll up and down the text file by using the arrow keys on the key board 20. If necessary, the user of the computer 11 may also enlarge or reduce the size of the letters of the text in the text file in case the user has some vision and is able to see very large letters.

Another important feature of the present invention is that the web browser 22 may send a retrieval signal 30 to the desired web page address 16. Preferably, the address 16 responds by sending back a response signal 32 that is received by the address 12 and the web browser 22 then converts the information in the response signal 32 to the file 23. In the alternative, the response signal 32 contains a text version of the information on the page address 16 so that no conversion by the web browser 22 is necessary. The information in the file 23 may be sent to the speech synthesizer software 15 by text information signal 24 from the address 12 to the computer 11. The speech synthesizer software 15 of the CD-rom 13 of the computer 11 then converts the signal 24 to speech and the sound may be transmitted via the speakers 14. All information displayed on a screen 26, should the user have some vision, is, preferably, in black and white to increase the contrast between the letters and the background.

While the present invention has been described in accordance with preferred compositions and embodiments, it is to be understood that certain substitutions and alterations may be made thereto without departing from the spirit and scope of the following claims.

1. A method for converting visual Internet information to sound, comprising:
activating a computer (11) with a program stored on a storage media (13);
the program (9) providing commands for connecting the computer (11) to an on-line oral web address (12):
the program (9) sending a connect signal (25) to the on-line oral web address (12);
the on-line oral web address (12) receiving the connect signal (25);
the on-line oral web address (12) sending a file (23) to a speech synthesizer software (15) of the computer (11); and
the speech synthesizer software (15) converting the file (23) to sound.

2. The method according to claim 1 wherein the method comprises loading a CD-rom (13) including the program (9) to the computer (11).

3. The method according to claim 1 wherein the method further comprises providing the on-line oral web address (12) with a web browser (22) that sends the file (23) to the speech synthesizer software (15).

4. The method according to claim 3 wherein the method further comprises the web browser (22) decoding the file (23) prior to sending the file (23) to the speech synthesizer software (15).

5. The method according to claim 1 wherein the method further comprises downloading a navigational program (18) from the on-line oral web address (12).

6. The method according to claim 5 wherein the method further comprises navigating the web browser (22) with the navigational program (18).

7. The method according to claim 1 wherein the method further comprises the web browser (22) sending a retrieval signal (30) to a web page address (16).

8. The method according to claim 8 wherein the method further comprises the web browser (22) receiving a response signal (32) from the web page address (16) and converting the response signal (32) to the file (23).

9. The method according to claim 1 wherein the method further comprises displaying information of the file (23) as text in black and white on a screen (26).

10. The method according to claim 1 wherein the method further comprises the speech synthesizer software (15) sending a sound signal to a loudspeaker (14) connected to the computer (11).
